(19) United States
(12) Patent Application Publication
(10) Pub. No.: US 2009/0129007 A1
(43) Pub. Date: May 21, 2009

(54) PERSONAL COMPUTER

(76) Inventor: Joseph Johannes Petrus Maria Muller, Den Bosch (NL)

Correspondence Address: PEACOCK MYERS, P.C., 201 THIRD STREET, N.W., SUITE 1340, ALBUQUERQUE, NM, 87102, US

(21) Appl. No.: 12/268,630

(22) Filed: Nov. 11, 2008

Related U.S. Application Data
(63) Continuation-in-part of application No. PCT/NL2007/050201, filed on May 9, 2007.

(30) Foreign Application Priority Data
May 11, 2006 (NL) 2000073

(51) Int. Cl. G06F 1/16

(52) U.S. Cl. 361/679.27; 361/679.21

(57) ABSTRACT

A personal computer, provided with a housing comprising at least a battery power supply, a processor and a memory, wherein the housing is divided into a first housing part and a second housing part that is hingingly coupled with the first housing part, and wherein the first housing part comprises a data entry unit and the second housing part comprises a visual display unit, and wherein the battery power supply is accommodated in the second housing part.

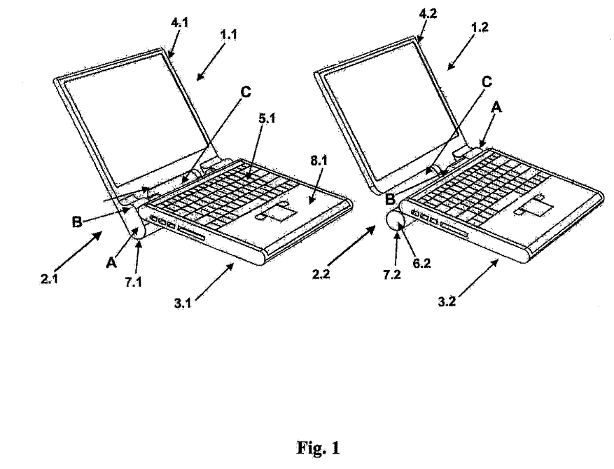

### CROSS-REFERENCE TO RELATED APPLICATIONS

This application is a continuation-in-part application of international patent application Serial No. PCT/NL2007/050201, entitled “Personal Computer”, to Jakob R. van den Berg and Joseph J. P. M. Muller, filed on May 9, 2007, and the specification and claims thereof are incorporated herein by reference.

This application claims priority to and the benefit of the filing of Netherlands Patent Application Serial No. 20000073, entitled “Personal Computer”, filed on May 11, 2006, and the specification and claims thereof are incorporated herein by reference.

### STATEMENT REGARDING FEDERALLY SPONSORED RESEARCH OR DEVELOPMENT

Not Applicable.

### STATEMENT REGARDING FEDERALLY SPONSORED RESEARCH OR DEVELOPMENT

Not Applicable.

### COPYRIGHTED MATERIAL

Not Applicable.

### BACKGROUND OF THE INVENTION

1. Field of the Invention (Technical Field)

The invention relates to a personal computer, which is provided with a housing comprising at least a battery power supply, a processor and a memory, and wherein the housing is divided into a first housing part and a second housing part that is hingingly coupled with the first housing part, and wherein the first housing part comprises a data entry unit and the second housing part comprises a visual display unit.

2. Description of Related Art

Such a personal computer is known from the American patent specification U.S. Pat. No. 5,901,035.

With this known personal computer a battery power supply is used, which is accommodated in a third housing part that is hingingly coupled with the first housing part and the second housing part. After opening out this third housing part, the first housing part comprising the data entry unit can be placed at an incline on a work surface so as to provide an ergonomical working position. By folding away the third housing part, terminals at the rear side of the first housing part are revealed, by which peripheral equipment can be connected to the personal computer.

### BRIEF SUMMARY OF THE INVENTION

The object of the invention is to provide a personal computer, which by opening the second housing part immediately provides a desired operational state.

A further object of the invention is to provide a personal computer in which the thermal management is optimised.

Still another object of the invention is to provide a personal computer, which is easier to transport and thus easier to handle.

Still another object of the invention is to provide a personal computer that is easier to assemble and that allows the replacement of components to take place more conveniently.

These and other objects of the invention are achieved with a personal computer, which is characterized by one or several of the appended claims.

### DETAILED DESCRIPTION OF THE INVENTION

In a first aspect of the invention, the personal computer is provided with a housing comprising at least one battery power supply, a processor and a memory, wherein the housing is divided into a first housing part and a second housing part that is hingingly coupled to the first housing part, and wherein the first housing part comprises a data entry unit, and the second housing part comprises a visual display unit, and wherein the battery power supply is accommodated in the second housing part.

The personal computer according to the invention thus comprises no more than two different housing parts that are hingingly coupled with each other. This in itself makes the assembly of the personal computer according to the invention already relatively simple and inexpensive. An additional advantage of this embodiment is that the battery power supply, which as such already forms a heat source, is separate from the processor and the memory that also form heat sources. This offers the possibility to optimise the cooling of the personal computer.

The personal computer according to the invention is suitably embodied such that the battery power supply is accommodated in the second housing part next to the visual display unit, and that a hinge coupling the first housing part with the second housing part is provided between the battery power supply and the visual display unit. This opens the way to various suitable embodiments and features of the personal computer according to the invention.

Usually the second housing part is movable between an operational state and a closed state. An important aspect of the personal computer according to the invention is that in the closed state, there is an open space between at least a portion of the second housing part and the first housing part, thereby forming a handgrip. This makes the personal computer very easy to handle and conveniently portable.

Another aspect relates to the fact that in the operational state an end of the second housing part forms a support for placing the first housing part at an incline. This is a simple and effective manner of providing an ergonomical working position at the personal computer according to the invention.

Still another aspect of the personal computer according to the invention relates to the embodiment wherein the data entry unit is hingingly or removably accommodated in the first housing part, and wherein the top side of the first housing part adjoining the data entry unit is substantially also hingingly or removably accommodated in the first housing part, and that immediately below said top side and the data entry unit a mother board is, or may be, provided. This affords considerable advantages with respect to assembly, since all the necessary components to be accommodated in the first housing part can be positioned from one side. In the prior art, the components have to be installed from both sides of the first housing part, making the assembly rather awkward.

A further aspect of the personal computer according to the invention relates to providing the terminals for peripheral equipment at a side of the first housing part.

### BRIEF DESCRIPTION OF THE SEVERAL VIEWS OF THE DRAWINGS

Hereinafter the invention will be further explained by way of two exemplary embodiments, which do not limit the claims, and with reference to the drawing.

In the drawing, a single FIGURE shows a first embodiment and a second embodiment of the personal computer according to the invention in an operational state. The FIGURE shows a first embodiment of the personal computer according to the invention, designated with reference numeral 1.1 and a second embodiment of such a personal computer, which is designated with reference numeral 1.2.

Both the embodiments of the personal computer 1.1 and 1.2 are provided with a housing 2.1, 2.2, comprising a battery power supply, a processor and a memory. This is completely known to the person skilled in the art and requires no further explanation.

As shown in the FIGURE, the housing 2.1 and 2.2 is divided into a first housing part 3.1, 3.2 and a second housing part 4.1, 4.2 that is hingingly coupled with the first housing part 3.1, 3.2.

As shown in the FIGURE, the first housing part 3.1 is embodied with a data entry unit 5.1. Such a data entry unit is, for example, a keyboard but may also relate to a mouse unit or the like. It will be obvious, that the first housing part 3.2 of the second embodiment 1.2 may also be provided with such a data entry unit.

The FIGURE further shows that the second housing part 4.1, 4.2 comprises a visual display unit. This second housing part 4.1, 4.2 also comprises the battery power supply located next to the visual display unit in the part indicated with arrow A. The hinge coupling the first housing part 3.1, 3.2 with the second housing part 4.1, 4.2 is shown to be positioned at arrow B between the battery power supply A and the visual display unit.

The FIGURE shows both embodiments of the personal computer according to the invention in the operational state. However, it will be obvious that the personal computer also has a closed state and that it can be adjusted between the operational state and the closed state by moving the second housing part 4.1, 4.2 in relation to the first housing part 3.1, 3.2.

When viewing the FIGURE, it will be obvious to the person skilled in the art that in the closed state there is an open space between at least a portion of the second housing part 4.1, 4.2, namely the portion indicated with arrow C, and the first housing part 3.1, 3.2, so as to form a handgrip. With respect to the second embodiment 1.2 of the personal computer according to the invention, this handgrip is indicated with reference numeral 6.2.

The FIGURE further clearly shows that in the operational state, an end 7.1, 7.2 of the second housing part 4.1, 4.2 provides a support for placing the first housing part 3.1, 3.2 at an incline.

Aside from the above given explanation regarding the embodiments 1.1 and 1.2 of the personal computer according to the invention as shown in the FIGURE, the data entry unit 5.1 may also be hingingly or removably accommodated in the first housing part 3.1, 3.2, and the top side 8.1 of the first housing part 3.1 immediately adjoining the data entry unit 5.1 may substantially also be hingingly or removably accommodated in the first housing part 3.1, while immediately below the top side 8.1 and data entry unit 5.1 a mother board is, or may be, provided. Such a measure is also useful for the personal computer according to the prior art, also when the battery power supply according to the prior art is accommodated in the first housing part. This concerns a separate invention, which may, however, be especially advantageously applied to the embodiments shown in the FIGURE. The manner in which this may be carried out is in the above context completely clear to the person skilled in the art, so that a further explanation and illustration in the FIGURE may be dispensed with. Likewise dispensable is the illustration of the embodiment of the personal computer according to the invention, wherein the terminals for peripheral equipment are provided at a side of the first housing part 3.1, 3.2.

What is claimed is:

1. A personal computer, provided with a housing comprising at least a battery power supply, a processor and a memory, wherein the housing is divided into a first housing part and a second housing part that is hingingly coupled with the first housing part, and wherein the first housing part comprises a data entry unit and the second housing part comprises a visual display unit, and wherein the battery power supply is accommodated in the second housing part.

2. A personal computer according to claim 1, wherein the battery power supply is accommodated in the second housing part next to the visual display unit, and wherein a hinge coupling the first housing part with the second housing part is provided between the battery power supply and the visual display unit.

3. A personal computer according to claim 1, wherein the second housing part is movable between an operational state and a closed state, and wherein in the closed state there is an open space between at least a portion of the second housing part and the first housing part, thereby forming a handgrip.

4. A personal computer according to claim 3, wherein in the operational state an end of the second housing part forms a support for placing the first housing part at an incline.

5. A personal computer according to claim 1, wherein the data entry unit is hingingly or removably accommodated in the first housing part, and the top side of the first housing part adjoining the data entry unit is substantially also hingingly or removably accommodated in the first housing part, and that immediately below said top side and the data entry unit a mother board is, or may be, provided.

6. A personal computer according to claim 5, wherein terminals for peripheral equipment are provided at a side of the first housing part.
